(19) United States
(12) Patent Application Publication
(10) Pub. No.: US 2026/0184327 A1
(43) Pub. Date: Jul. 2, 2026

(54) VEHICLE CONTROL SYSTEM

(71) Applicant: TOYOTA JIDOSHA KABUSHIKI KAISHA, Toyota-shi (JP)

(72) Inventors: Kensuke SHINOMOTO, Okazaki-shi (JP); Yoichiro Isami, Mishima-shi (JP); Ryohei Yuasa, Okazaki-shi (JP)

(73) Assignee: TOYOTA JIDOSHA KABUSHIKI KAISHA, Toyota-shi (JP)

(21) Appl. No.: 19/426,755

(22) Filed: Dec. 19, 2025

(30) Foreign Application Priority Data
Dec. 26, 2024 (JP) 2024-230590

(51) Int. Cl. B60W 50/14; B60L 15/20

(52) U.S. Cl. CPC B60W 50/14; B60L 15/20; B60L 2240/423

(57) ABSTRACT

A vehicle control system is applied to a vehicle including an electric motor as a driving source. In a simulation mode, the vehicle control system controls the electric motor so as to simulate a driving characteristic of a virtual engine car. Specifically, in the simulation mode, the vehicle control system calculates a virtual engine output torque of the virtual engine car based on an accelerator operation amount of the vehicle. The vehicle control system controls the electric motor in accordance with a required torque obtained from the virtual engine output torque. The vehicle control system starts torque-based notification processing of superimposing an additional torque component onto the required torque when a notification start condition is satisfied.

### CROSS-REFERENCE TO RELATED APPLICATION

This application claims priority to Japanese Patent Application No. 2024-230590 filed on Dec. 26, 2024. The disclosure of the above-identified application, including the specification, drawings, and claims, is incorporated by reference herein in its entirety.

### BACKGROUND

### 1. Technical Field

The present disclosure relates to a vehicle control system applied to a vehicle including an electric motor as a driving source. In particular, the present disclosure relates to a technology that simulates a virtual engine car in a vehicle including an electric motor as a driving source.

### 2. Description of Related Art

Japanese Unexamined Patent Application Publication No. 2022-034648 (JP 2022-034648 A) discloses an electrified vehicle capable of reproducing the behavior of a vehicle in a manual transmission (MT) car in a simulated manner. A virtual engine rotation speed of a virtual MT car changes in accordance with the operation amount of an accelerator pedal by a driver. When the virtual engine rotation speed becomes equal to or more than a preset threshold value (upper-limit rotation speed), a control device makes the driver recognize that the virtual engine rotation speed has reached the upper-limit rotation speed by simulating a fuel cut in a normal MT car. At this time, in order to simulate a fuel cut in a normal MT car, the control device automatically reduces the virtual engine output torque by controlling the intake air amount and the fuel injection control amount of the virtual engine.

### SUMMARY

An electric vehicle including a simulation mode that simulates a driving characteristic of the virtual engine car is conceived. There is a possibility that a situation may occur in which some kind of notification is desired to be given to the driver in the middle of the simulation mode. At this time, it is desired that the notification be suitably given to the driver.

As a comparative example, the technology described in JP 2022-034648 A described above is conceived. According to JP 2022-034648 A described above, when the virtual engine rotation speed becomes equal to or more than the preset threshold value (upper-limit rotation speed), control for making the driver recognize that the virtual engine rotation speed has become equal to or more than the preset threshold value is performed. Specifically, the control device simulates a fuel cut by controlling the intake air amount and the fuel injection control amount of the virtual engine and automatically reducing the virtual engine output torque. However, the magnitude and the frequency of the fluctuation (vibration) of the virtual engine output torque caused by such control is highly dependent on the driving environment at the time of calculation of the virtual engine output torque. Therefore, there is a concern that a torque vibration for notifying the driver of the fuel cut may not be obtained as expected depending on the driving environment. In other words, there is a concern that a notification as intended may not given to the driver depending on the driving environment.

In JP 2022-034648 A described above, control when the virtual engine rotation speed is largely reduced is disclosed, but nothing about control when the virtual engine rotation speed becomes equal to or more than the threshold value is disclosed. According to JP 2022-034648 A, a notification indicating that the virtual engine rotation speed has largely reduced cannot be given to the driver. Therefore, there is a risk that an engine stall may occur in the middle of the simulation of the virtual engine car.

The present disclosure provides a vehicle control system that suitably notifies a driver in a simulation mode that simulates a driving characteristic of a virtual engine car.

A vehicle control system according to a first aspect of the present disclosure is applied to a vehicle including an electric motor as a driving source. The vehicle control system includes one or more processors configured to control the electric motor so as to simulate a driving characteristic of a virtual engine car in a simulation mode. In the simulation mode, the one or more processors are configured to calculate a virtual engine output torque of the virtual engine car based on an accelerator operation amount of the vehicle. In the simulation mode, the one or more processors are configured to control the electric motor in accordance with a required torque obtained from the virtual engine output torque. In the simulation mode, the one or more processors are configured to start torque-based notification processing of superimposing an additional torque component onto the required torque when a notification start condition is satisfied.

In the vehicle control system according to the first aspect of the present disclosure, the additional torque component may be a torque vibration component.

In the vehicle control system according to the first aspect of the present disclosure, the torque vibration component may be superimposed onto the required torque for a predetermined amount of time.

The vehicle control system according to the first aspect of the present disclosure may further include one or more storage devices configured to store therein a virtual engine torque map that defines a relationship between the accelerator operation amount and the virtual engine output torque. In the simulation mode, the one or more processors may be configured to calculate a virtual engine output torque in accordance with an accelerator operation amount by using the virtual engine torque map. In the simulation mode, the one or more processors may be configured to set the additional torque component without using the virtual engine torque map.

In the vehicle control system according to the first aspect of the present disclosure, the one or more processors may be configured to end the torque-based notification processing when a notification end condition is satisfied after the torque-based notification processing is started.

In the vehicle control system according to the first aspect of the present disclosure, the notification end condition may be a condition that a predetermined amount of time elapses from the start of the torque-based notification processing.

In the vehicle control system according to the first aspect of the present disclosure, the notification end condition may be a condition that the notification start condition is no longer satisfied.

In the vehicle control system according to the first aspect of the present disclosure, the one or more processors may be configured to calculate a virtual engine rotation speed of the virtual engine car in the simulation mode. The notification start condition may include a condition that the virtual engine rotation speed becomes equal to or more than a first actuation threshold value.

In the vehicle control system according to the first aspect of the present disclosure, the first actuation threshold value may be an upper-limit value of an engine rotation speed that is assumed in the virtual engine car to be simulated.

In the vehicle control system according to the first aspect of the present disclosure, the additional torque component when the accelerator operation amount is a first accelerator operation amount may be larger than the additional torque component when the accelerator operation amount is a second accelerator operation amount that is lower than the first accelerator operation amount.

In the vehicle control system according to the first aspect of the present disclosure, the one or more processors may be configured to end the torque-based notification processing when a predetermined amount of time elapses from the start of the torque-based notification processing. The one or more processors may be configured to automatically set a gear stage of the virtual engine car to a predetermined appropriate gear stage when the torque-based notification processing is ended.

In the vehicle control system according to the first aspect of the present disclosure, the one or more processors may be configured to calculate a virtual engine rotation speed of the virtual engine car in the simulation mode. The notification start condition may include a condition that the virtual engine rotation speed becomes equal to or less than a second actuation threshold value.

In the vehicle control system according to the first aspect of the present disclosure, the one or more processors may be configured to calculate a virtual engine rotation speed of the virtual engine car in the simulation mode. The notification start condition may include a condition that the virtual engine rotation speed is equal to or more than a first actuation threshold value or a condition that the virtual engine rotation speed becomes equal to or less than a second actuation threshold value lower than the first actuation threshold value.

A vehicle control system according to a second aspect of the present disclosure relates to a vehicle control system applied to a vehicle including an electric motor as a driving source. The vehicle control system includes one or more processors configured to control the electric motor so as to simulate a driving characteristic of a virtual engine car in a simulation mode. The one or more processors are configured to calculate a virtual engine rotation speed of the virtual engine car in the simulation mode. In the simulation mode, the one or more processors are configured to start notification processing of notifying a driver of the vehicle that the virtual engine rotation speed has become equal to or less than a threshold value when the virtual engine rotation speed becomes equal to or less than the threshold value.

In the vehicle control system according to the second aspect of the present disclosure, the one or more processors may be configured to calculate a virtual engine output torque of the virtual engine car based on an accelerator operation amount of the vehicle in the simulation mode. In the simulation mode, the one or more processors may be configured to control the electric motor in accordance with a required torque obtained from the virtual engine output torque. The notification processing may include torque-based notification processing of superimposing an additional torque component onto the required torque.

In the vehicle control system according to the second aspect of the present disclosure, the additional torque component may be a torque vibration component.

According to the first aspect, in the simulation mode, the electric motor is controlled such that a driving characteristic of a virtual engine car is simulated. More specifically, a virtual engine output torque of the virtual engine car is calculated based on an accelerator operation amount of the vehicle. An electric motor is controlled in accordance with a required torque obtained from the virtual engine output torque. Meanwhile, when the notification start condition is satisfied, an additional torque component is superimposed onto the required torque. The additional torque component superimposed onto the required torque serves as a notification to the driver. The additional torque component is prepared separately from the virtual engine output torque. In other words, the additional torque component can be freely set independent of the virtual engine output torque without being affected by the virtual engine output torque. By superimposing a freely-selected independent additional torque component onto the required torque as above, it becomes possible to notify the driver as intended regardless of the driving environment. In other words, according to a first point of view, it becomes possible to suitably notify the driver in the middle of the simulation mode.

According to the second aspect, in the simulation mode, the electric motor is controlled such that a driving characteristic of a virtual engine car is simulated. When the virtual engine rotation speed of the virtual engine car becomes equal to or less than a threshold value, notification processing for notifying the driver that the virtual engine rotation speed of the virtual engine car has become equal to or less than the threshold value is executed. As above, the driver is notified that the virtual engine rotation speed has become equal to or less than a threshold value. As a result, the engine stall is inhibited from occurring in the middle of the simulation mode. In other words, according to a second point of view, it becomes possible to suitably notify the driver in the middle of the simulation mode.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a conceptual diagram showing a vehicle and a vehicle control system;

FIG. 2 is a block diagram showing a basic functional configuration example relating to a simulation mode;

FIG. 3 is a conceptual diagram for describing an overview of notification processing in the simulation mode;

FIG. 4 is a block diagram showing a functional configuration example relating to the notification processing in the simulation mode;

FIG. 5 is a block diagram showing a functional configuration example relating to the notification processing in the simulation mode;

FIG. 6 is a flowchart showing a first example of processing relating to the notification processing in the simulation mode;

FIG. 7 is a flowchart showing an example of notification processing in stages in the simulation mode;

FIG. 8 is a flowchart showing a second example of the processing relating to the notification processing in the simulation mode;

FIG. 9 is a flowchart showing a third example of the processing relating to the notification processing in the simulation mode;

FIG. 10 is a block diagram showing a functional configuration example relating to a first example of torque-based notification processing in the simulation mode;

FIG. 11 is a timing chart for describing the first example of the torque-based notification processing in the simulation mode;

FIG. 12 is a block diagram showing a functional configuration example relating to a second example of the torque-based notification processing in the simulation mode;

FIG. 13A is a timing chart for describing the second example of the torque-based notification processing in the simulation mode;

FIG. 13B is a timing chart for describing the second example of the torque-based notification processing in the simulation mode;

FIG. 14 is a timing chart for describing a third example of the torque-based notification processing in the simulation mode;

FIG. 15 is a block diagram showing a functional configuration example relating to a fourth example of the torque-based notification processing in the simulation mode;

FIG. 16 is a block diagram showing a first configuration example of a motive power control system of an electric vehicle;

FIG. 17 is a diagram showing each example of an engine model, a clutch model, and a transmission model that constitute an MT vehicle model;

FIG. 18 shows a torque characteristic of an electric motor realized through motor control using the MT vehicle model; and

FIG. 19 is a block diagram showing a second configuration example of the motive power control system of the electric vehicle.

### DETAILED DESCRIPTION OF EMBODIMENTS

An embodiment of the present disclosure is described with reference to the accompanying drawings.

### 1. Vehicle and Vehicle Control System

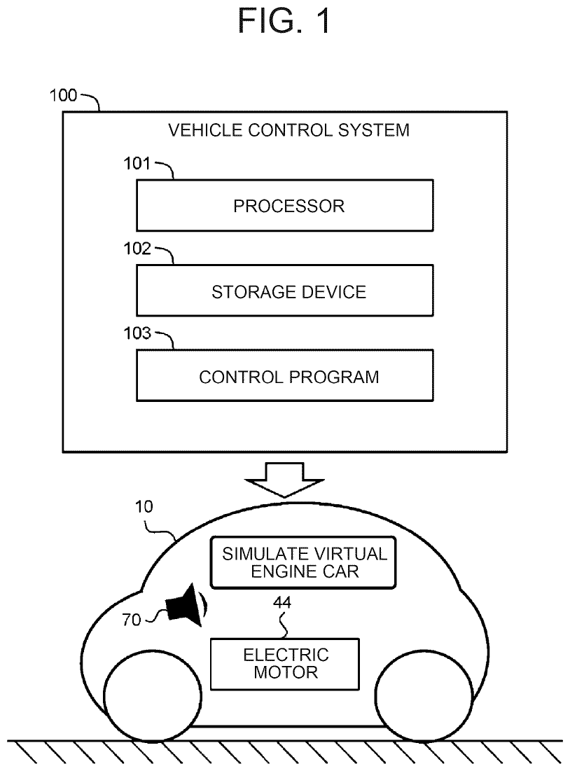

FIG. 1 is a conceptual diagram showing a vehicle 10 and a vehicle control system 100 according to an embodiment of the present disclosure. For example, the vehicle 10 is an electric vehicle that uses an electric motor 44 as a travel driving source. Examples of the electric motor 44 include a brushless DC motor and a three-phase synchronous motor. For example, the vehicle 10 is a battery electric vehicle (BEV). Other examples of the vehicle 10 may include a hybrid electric vehicle (HEV), a plug-in hybrid electric vehicle (PHEV), and a fuel cell electric vehicle (FCEV).

The vehicle control system 100 is applied to the vehicle 10 and controls the vehicle 10. The entire vehicle control system 100 may be equipped in the vehicle 10. As another example, at least part of the vehicle control system 100 may be included in an external management server outside of the vehicle 10. In this case, the vehicle control system 100 may remotely control the vehicle 10. As yet another example, the vehicle control system 100 may be distributed between the vehicle 10 and the management server.

In general, the vehicle control system 100 includes one or more processors 101 (hereinafter simply referred to as a processor 101) and one or more storage devices 102 (hereinafter simply referred to as a storage device 102). The processor 101 executes various processing. Examples of the processor 101 include a general-purpose processor, a specific-use processor, a central processing unit (CPU), a graphics processing unit (GPU), an application specific integrated circuit (ASIC), a field-programmable gate array (FPGA), an integrated circuit, a conventional circuit, and/or combinations thereof. The processor 101 can also be referred to as a circuitry or a processing circuitry. The circuitry is hardware programmed to implement described functions, or hardware that executes functions. The storage device 102 stores various kinds of information therein. Examples of the storage device 102 include a volatile memory, a non-volatile memory, a hard disk drive (HDD), and a solid state drive (SSD). Functions of the vehicle control system 100 are realized by the cooperation between the processor 101 and the storage device 102.

One or more control programs 103 (hereinafter simply referred to as a control program 103) are computer programs executed by the processor 101. Functions of the vehicle control system 100 may be realized by the cooperation between the processor 101 that executes the control program 103 and the storage device 102. The control program 103 is stored in the storage device 102. Alternatively, the control program 103 may be recorded on a computer-readable recording medium.

### 2. Simulation Mode

The vehicle control system 100 according to the present embodiment includes a “simulation mode” that simulates (reproduces) a virtual engine car. The virtual engine car to be simulated is a type of vehicle that is different from that of the vehicle 10. The virtual engine car to be simulated may be a manual transmission (MT) vehicle.

For example, in the simulation mode, the vehicle control system 100 simulates a driving characteristic of the virtual engine car. In this case, the vehicle control system 100 controls the electric motor 44 of the vehicle 10 so as to simulate the driving characteristic of the virtual engine car. Specific examples of the simulation of the driving characteristic of the virtual engine car are described in Section 5 below.

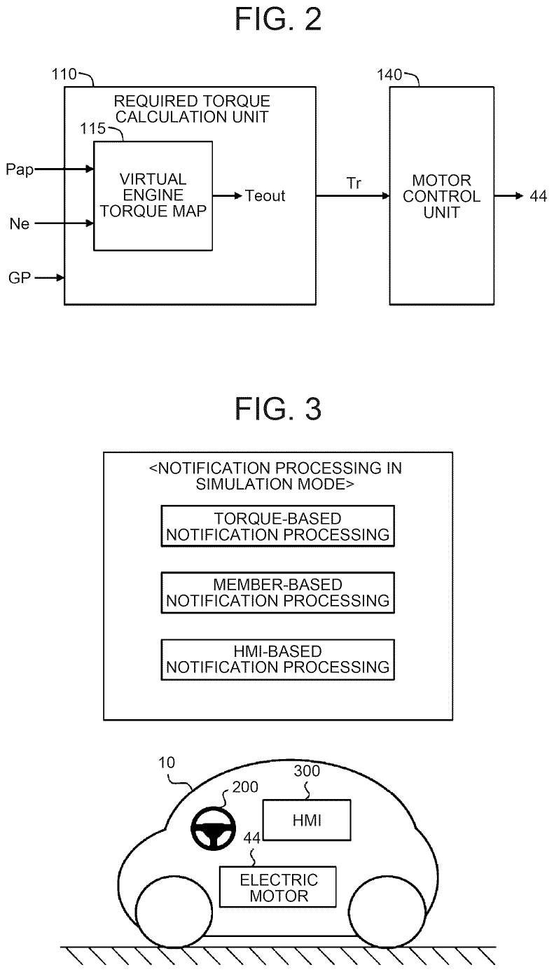

FIG. 2 is a block diagram showing a basic functional configuration example relating to the simulation of the driving characteristic of the virtual engine car. The vehicle control system 100 includes a required torque calculation unit 110 and a motor control unit 140.

An accelerator operation amount Pap is an operation amount of an accelerator pedal of the vehicle 10 operated by a driver. The accelerator operation amount Pap is detected by an accelerator position sensor provided on the accelerator pedal of the vehicle 10.

A virtual engine rotation speed Ne is a virtual engine rotation speed when it is assumed that the vehicle 10 is driven by the virtual engine. For example, the virtual engine rotation speed Ne is calculated so as to increase as the wheel speed of the vehicle 10 increases. The virtual engine rotation speed Ne may be calculated based on the wheel speed, the total speed reduction ratio, and the virtual clutch slip ratio. Details of a method for calculating the virtual engine rotation speed Ne are described in Section 5 below.

A virtual gear stage GP is a gear stage in a virtual transmission. When the virtual engine car is an MT car, the vehicle 10 may include a pseudo-shifter manually operated by the driver. In this case, the virtual gear stage GP is specified by the operation of the pseudo-shifter by the driver.

The required torque calculation unit 110 calculates a required torque Tr equivalent to the driving force of the vehicle 10. More specifically, the required torque calculation unit 110 includes a virtual engine torque map 115. The input to the virtual engine torque map 115 includes the accelerator operation amount Pap and the virtual engine rotation speed Ne. The output from the virtual engine torque map 115 is a virtual engine output torque Teout that is an output torque of the virtual engine. The virtual engine torque map 115 is designed such that the accelerator operation amount Pap and the virtual engine rotation speed Ne are input and the virtual engine output torque Teout is output. It can be said that the virtual engine torque map 115 is a map that defines the relationships among the accelerator operation amount Pap, the virtual engine rotation speed Ne, and the virtual engine output torque Teout. The virtual engine torque map 115 is generated in advance and is stored in the storage device 102. The required torque calculation unit 110 calculates the virtual engine output torque Teout in accordance with the accelerator operation amount Pap and the virtual engine rotation speed Ne by using the virtual engine torque map 115.

The required torque calculation unit 110 calculates a drive wheel torque Tw from the virtual engine output torque Teout by taking the virtual gear stage GP, the speed reduction ratio, and the like into consideration. The drive wheel torque Tw is a torque required for a drive wheel of the vehicle 10. A required motor torque Tm is a motor torque required for the electric motor 44 in order to realize the drive wheel torque Tw. The drive wheel torque Tw can be converted into the required motor torque Tm by using the speed reduction ratio from an output shaft of the electric motor 44 to the drive wheel. The required torque calculation unit 110 outputs the drive wheel torque Tw or the required motor torque Tm as the required torque Tr.

The motor control unit 140 controls the electric motor 44 in accordance with the required torque Tr. As above, the driving characteristic of the virtual engine car is simulated in the vehicle 10.

As another example, in the simulation mode, the vehicle control system 100 may simulate the engine sound of the virtual engine car. The vehicle 10 is equipped with one or more speakers 70 (see FIG. 1). The vehicle control system 100 generates a pseudo-engine sound that simulates the engine sound of the virtual engine car and outputs the pseudo-engine sound through the speaker 70 of the vehicle 10. For example, the frequency of the pseudo-engine sound changes in proportion to the virtual engine rotation speed Ne. The sound pressure of the pseudo-engine sound may be changed in proportion to the virtual engine output torque Teout.

By the simulation mode above, the driver of the vehicle 10 can experience a sensation as if driving the virtual engine car.

### 3. Notification to Driver in Simulation Mode

### 3-1. Outline

There is a possibility that a situation may occur in which some kind of notification is desired to be given to the driver of the vehicle 10 in the middle of the simulation mode that simulates the virtual engine car. For example, when the virtual engine rotation speed Ne becomes excessively high, there may be a need to notify the driver of that information. As another example, when the virtual engine rotation speed Ne becomes excessively low, there also may be a need to notify the driver of that information. In the middle of the simulation mode, a notification is desired to be suitably given to the driver of the vehicle 10.

The vehicle control system 100 according to the present embodiment is configured to be able to notify the driver of the vehicle 10 as needed in the middle of the simulation mode. Processing relating to the notification performed by the vehicle control system 100 in the middle of the simulation mode is hereinafter simply referred to as “notification processing”.

FIG. 3 is a conceptual diagram for describing an outline of the notification processing by the vehicle control system 100 according to according to the present embodiment. As the type of the notification processing, various types are conceived. Three types, that is, “torque-based notification processing”, “member-based notification processing”, and “HMI-based notification processing” are exemplified below. The notification processing may include at least one of the “torque-based notification processing”, the “member-based notification processing ”, and the “HMI-based notification processing”.

The torque-based notification processing is processing of superimposing an “additional torque component Tadd” onto the required torque Tr for controlling the electric motor 44. As described above, the virtual engine output torque Teout is calculated based on the virtual engine torque map 115, and the required torque Tr is obtained from the virtual engine output torque Teout. The additional torque component Tadd is prepared separately from the virtual engine output torque Teout. In other words, the additional torque component Tadd can be freely designed independent of the virtual engine output torque Teout without being affected by the virtual engine output torque Teout. The freely-selected independent additional torque component Tadd as above serves as a notification to the driver of the vehicle 10. The additional torque component Tadd may be a torque vibration component. The motor control unit 140 controls the electric motor 44 in accordance with the required torque Tr after the additional torque component Tadd is superimposed. The driving force and the behavior of the vehicle 10 fluctuate by the amount of the additional torque component Tadd. As a result, the driver can acknowledge the notification from the vehicle control system 100.

The member-based notification processing is processing of vibrating the member 200 equipped in the vehicle 10. The member 200 is typically brought into contact with the driver of the vehicle 10. For example, the member 200 is a steering wheel operated by the driver. As another example, the member 200 may be a seat that the driver sits on. The vibration of the member 200 serves as a notification to the driver of the vehicle 10. The driver can acknowledge the notification from the vehicle control system 100 as a result of the vibration of the member 200.

The HMI-based notification processing is notification processing via a human machine interface (HMI) 300 equipped in the vehicle 10. Examples of the HMI 300 include a display, a touch screen, a meter, a head up display (HUD), and a speaker. Notification of visual information or voice information is given to the driver via the HMI 300. As a result, the driver can acknowledge the notification from the vehicle control system 100.

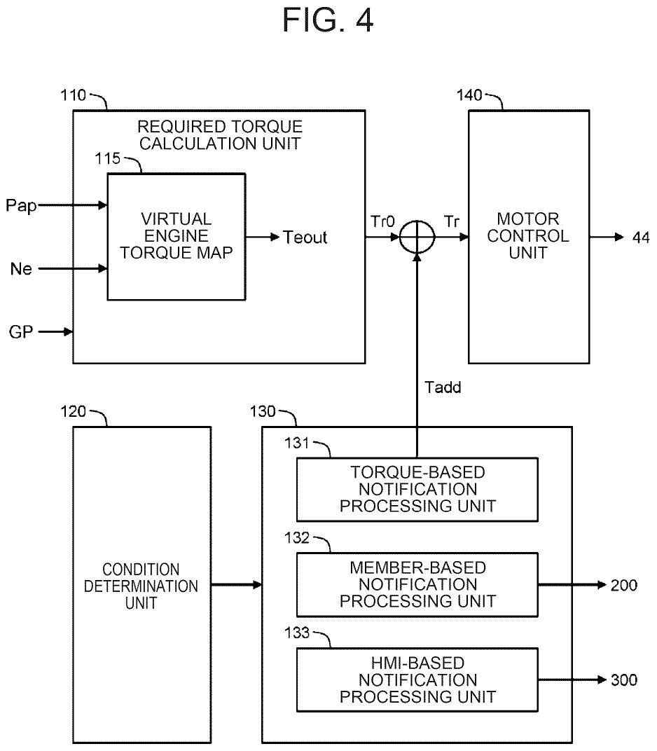

FIG. 4 is a block diagram showing a functional configuration example relating to the notification processing in the simulation mode. The vehicle control system 100 further includes a condition determination unit 120 and a notification processing unit 130.

The condition determination unit 120 determines whether a “notification start condition” for performing the notification processing is satisfied. The notification start condition is freely selected. Examples of the notification start condition are described later. When the notification start condition is satisfied, the condition determination unit 120 instructs the notification processing unit 130 to start the notification processing.

After the start of the notification processing, the condition determination unit 120 determines whether a “notification end condition” for ending the notification processing is satisfied. The notification end condition is freely selected. Examples of the notification end condition are described later. When the notification end condition is satisfied, the condition determination unit 120 instructs the notification processing unit 130 to end the notification processing.

The notification processing unit 130 executes the notification processing. The notification processing unit 130 includes at least one of a torque-based notification processing unit 131, a member-based notification processing unit 132, and an HMI-based notification processing unit 133.

The torque-based notification processing unit 131 executes the torque-based notification processing. More specifically, the torque-based notification processing unit 131 sets the additional torque component Tadd. The additional torque component Tadd is set independently of the calculation of the required torque Tr in the required torque calculation unit 110. In other words, the additional torque component Tadd is prepared separately from the virtual engine output torque Teout. The torque-based notification processing unit 131 sets the additional torque component Tadd without using the virtual engine torque map 115. The additional torque component Tadd may be a torque vibration component. The required torque Tr calculated by the required torque calculation unit 110 is referred to as the basic required torque Tr0 for convenience. The torque-based notification processing unit 131 acquires the final required torque Tr by superimposing the additional torque component Tadd onto the basic required torque Tr0 output from the required torque calculation unit 110. The motor control unit 140 controls the electric motor 44 in accordance with the required torque Tr after the additional torque component Tadd is superimposed.

The member-based notification processing unit 132 executes the member-based notification processing. Specifically, the member-based notification processing unit 132 vibrates the member 200 equipped in the vehicle 10.

The HMI-based notification processing unit 133 executes the HMI-based notification processing. More specifically, the HMI-based notification processing unit 133 notifies the driver of the visual information or the voice information through the HMI 300.

As described above, according to the present embodiment, it becomes possible to notify the driver in the middle of the simulation mode that simulates the engine car.

With the torque-based notification processing according to the present embodiment, a technical effect as follows is further obtained. First, in order to describe the technical effect of the torque-based notification processing according to the present embodiment, a technology described in JP 2022-034648 A described above is conceived as a comparative example.

According to JP 2022-034648 A described above, when the virtual engine rotation speed Ne becomes equal to or more than a preset threshold value (upper-limit rotation speed), control for making the driver recognize that the virtual engine rotation speed has become equal to or more than the preset threshold value is performed. Specifically, the control device simulates a fuel cut by controlling the intake air amount and the fuel injection control amount of the virtual engine and automatically reducing the virtual engine output torque Teout. However, the magnitude and the frequency of the fluctuation (vibration) of the virtual engine output torque Teout caused by such control is highly dependent on the driving environment when the virtual engine output torque Teout is calculated. Therefore, there is a concern that the torque vibration for notifying the driver of the fuel cut may not be obtained as expected depending on the driving environment. In other words, there is a concern that a notification as intended may not given to the driver depending on the driving environment.

Meanwhile, according to the present embodiment, the additional torque component Tadd is superimposed onto the required torque Tr for controlling the electric motor 44. The additional torque component Tadd superimposed onto the required torque Tr serves as a notification to the driver. The additional torque component Tadd is prepared separately from the virtual engine output torque Teout. In other words, the additional torque component Tadd can be freely set independent of the virtual engine output torque Teout without being affected by the virtual engine output torque Teout. By superimposing the freely-selected independent additional torque component Tadd onto the required torque Tr as above, it becomes possible to notify the driver as intended regardless of the driving environment. In other words, according to the present embodiment, it becomes possible to suitably notify the driver in the middle of the simulation mode.

### 3-2. Various Examples of Notification Processing

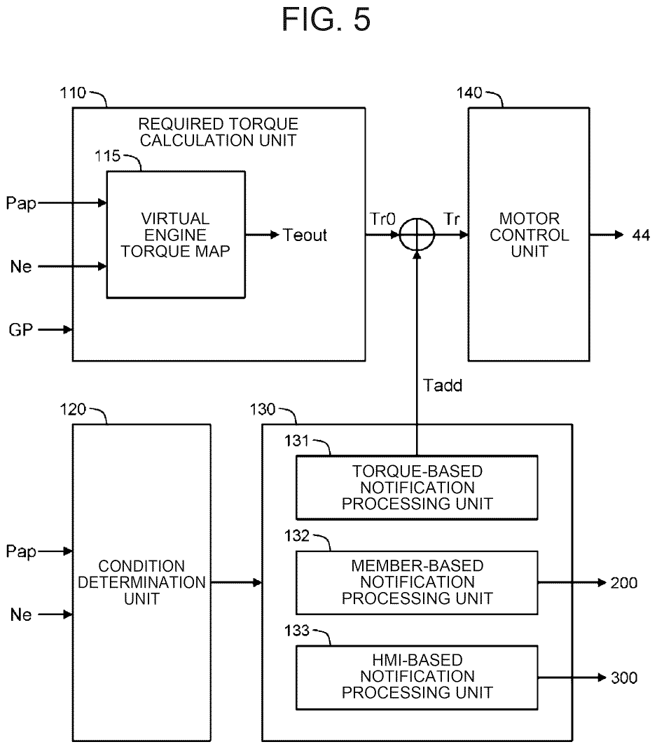

Various examples of the notification processing in the simulation mode are described below. In this example, as shown in FIG. 5, the virtual engine rotation speed Ne and the accelerator operation amount Pap are input to the condition determination unit 120.

### 3-2-1. First Example

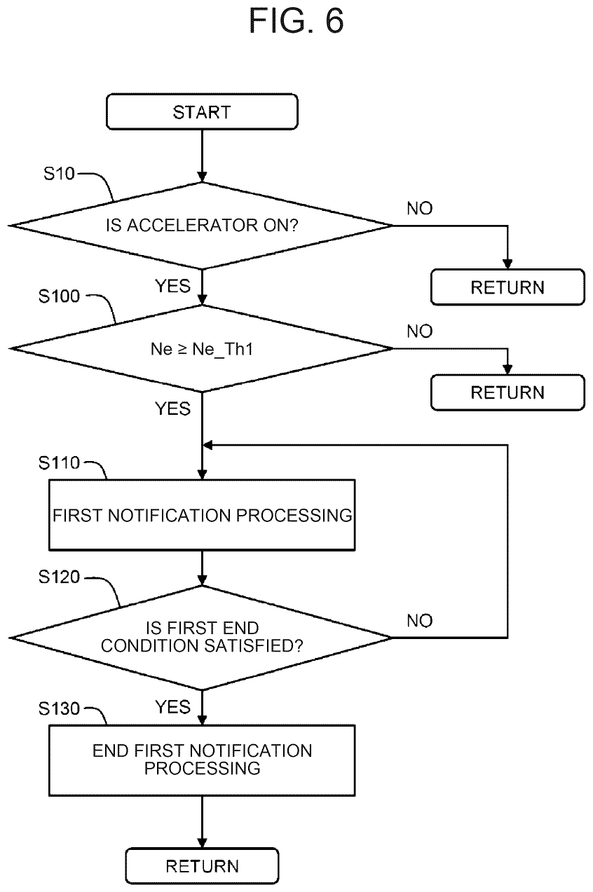

FIG. 6 is a flowchart showing a first example of processing relating to the notification processing in the simulation mode.

In Step S10, the condition determination unit 120 determines whether the driver is stepping on an accelerator pedal based on the accelerator operation amount Pap. When the driver is not stepping on the accelerator pedal (Step S10; No), the processing in this cycle ends. Meanwhile, when the driver is stepping on the accelerator pedal (Step S10; Yes), the processing proceeds to Step S100.

In Step S100, the condition determination unit 120 determines whether a first start condition (notification start condition) is satisfied. The first start condition is that the virtual engine rotation speed Ne becomes equal to or more than a first actuation threshold value Ne_Th1. The condition determination unit 120 determines whether the first start condition is satisfied based on the virtual engine rotation speed Ne. When the virtual engine rotation speed Ne is less than the first actuation threshold value Ne_Th1 (Step S100; No), the processing in this cycle ends. Meanwhile, when the virtual engine rotation speed Ne becomes equal to or more than the first actuation threshold value Ne_Th1 (Step S100; Yes), the processing proceeds to Step S110.

In Step S110, the notification processing unit 130 executes first notification processing. The first notification processing is processing for notifying the driver of the vehicle 10 that the virtual engine rotation speed Ne has become equal to or more than the first actuation threshold value Ne_Th1. The first notification processing includes at least one of the torque-based notification processing, the member-based notification processing, and the HMI-based notification processing.

By the first notification processing, it becomes possible to notify the driver that the virtual engine rotation speed Ne has become excessively high, for example. As a result, it is expected that the driver reduces the depression of the accelerator pedal and the virtual engine rotation speed Ne is reduced. As one example, the first actuation threshold value Ne_Th1 may be an upper-limit value of the engine rotation speed assumed in the virtual engine car to be simulated. In this case, it becomes possible to notify the driver that the virtual engine rotation speed Ne has reached the assumed upper-limit value.

In Step S120, the condition determination unit 120 determines whether a first end condition (notification end condition) is satisfied.

One example of the first end condition is a condition that the virtual engine rotation speed Ne becomes lower than the first actuation threshold value Ne_Th1. This is the same as the first start condition no longer being satisfied. The condition determination unit 120 determines whether the first end condition is satisfied based on the virtual engine rotation speed Ne.

Another example of the first end condition is a condition that a predetermined amount of time elapses from the start of the first notification processing. The predetermined amount of time is about one second, for example.

Yet another example of the first end condition is a condition that the driver stops stepping on the accelerator pedal. The condition determination unit 120 determines whether the first end condition is satisfied based on the accelerator operation amount Pap.

Step S110 is repeatedly executed until the first end condition is satisfied. When the first end condition is satisfied (Step S120; Yes), the processing proceeds to Step S130.

In Step S130, the notification processing unit 130 ends the first notification processing.

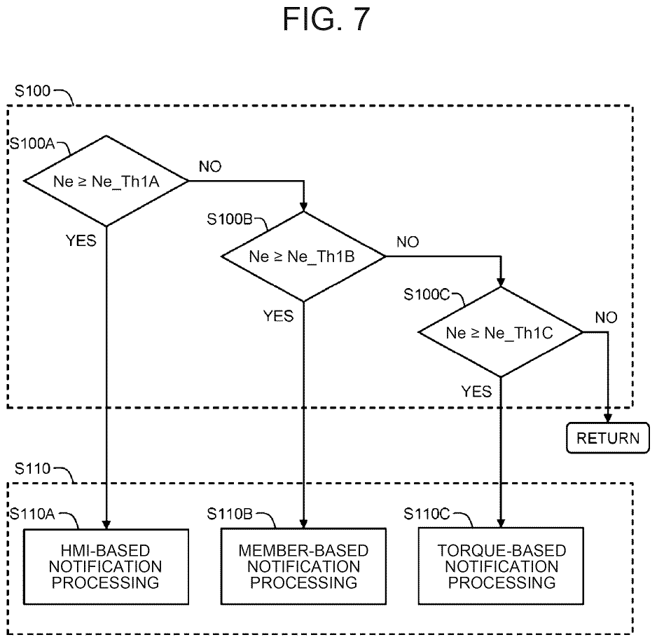

A plurality of types of the first notification processing may be performed in stages. FIG. 7 is a flowchart showing an example of notification processing in stages. In the example shown in FIG. 7, three types, that is, actuation threshold values Ne_Th1A, Ne_Th1B, Ne_Th1C are prepared as the first actuation threshold value Ne_Th1 are prepared. The actuation threshold value Ne_Th1A is higher than the actuation threshold value Ne_Th1B, and the actuation threshold value Ne_Th1B is higher than the actuation threshold value Ne_Th1C. When the virtual engine rotation speed Ne is equal to or more than the actuation threshold value Ne_Th1C and is less than the actuation threshold value Ne_Th1B (Step S100C; Yes), the torque-based notification processing is executed (Step S110C). When the virtual engine rotation speed Ne is equal to or more than the actuation threshold value Ne_Th1B and is less than the actuation threshold value Ne_Th1A (Step S100B; Yes), the member-based notification processing is executed (Step S110B). When the virtual engine rotation speed Ne becomes equal to or more than the actuation threshold value Ne_Th1A (Step S100A; Yes), the HMI-based notification processing is executed (Step S110A). As above, the first notification processing is performed in stages such that the driver can acknowledge the notification more directly as the virtual engine rotation speed Ne increases.

The first notification processing in stages is not limited to the example shown in FIG. 7.

### 3-2-2. Second Example

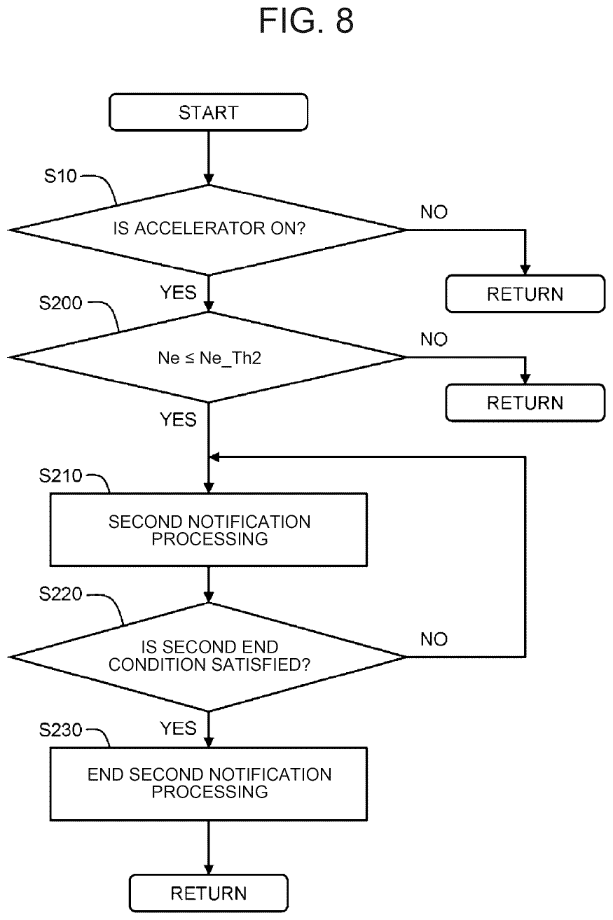

FIG. 8 is a flowchart showing a second example of the processing relating to the notification processing in the simulation mode. Step S10 is similar to the case of the first example described above. When the driver is stepping on the accelerator pedal (Step S10; Yes), the processing proceeds to Step S200.

In Step S200, the condition determination unit 120 determines whether a second start condition (notification start condition) is satisfied. The second start condition is that the virtual engine rotation speed Ne becomes equal to or less than a second actuation threshold value Ne_Th2. The second actuation threshold value Ne_Th2 is lower than the first actuation threshold value Ne_Th1 in the first example. The condition determination unit 120 determines whether the second start condition is satisfied based on the virtual engine rotation speed Ne. When the virtual engine rotation speed Ne is higher than the second actuation threshold value Ne_Th2 (Step S200; No), the processing in this cycle ends. Meanwhile, when the virtual engine rotation speed Ne becomes equal to or less than the second actuation threshold value Ne_Th2 (Step S200; Yes), the processing proceeds to Step S210.

In Step S210, the notification processing unit 130 executes the second notification processing. The second notification processing is processing for notifying the driver of the vehicle 10 that the virtual engine rotation speed Ne has become equal to or less than the second actuation threshold value Ne_Th2. The second notification processing includes at least one of the torque-based notification processing, the member-based notification processing, and the HMI-based notification processing.

By the second notification processing, it becomes possible to notify the driver that the virtual engine rotation speed Ne has become excessively low, for example. As a result, it is expected that the driver depresses the accelerator pedal and the virtual engine rotation speed Ne rises. The virtual engine rotation speed Ne is prevented from being reduced more than necessary, and hence the occurrence of an engine stall in the middle of the simulation mode is inhibited.

In Step S220, the condition determination unit 120 determines whether the second end condition (notification end condition) is satisfied.

One example of the second end condition is a condition that the virtual engine rotation speed Ne becomes higher than the second actuation threshold value Ne_Th2. This is the same as the second start condition no longer being satisfied. The condition determination unit 120 determines whether the second end condition is satisfied based on the virtual engine rotation speed Ne.

Another example of the second end condition is a condition that a predetermined amount of time elapses from the start of the second notification processing. The predetermined amount of time is about one second, for example.

Step S210 is repeatedly executed until the second end condition is satisfied. When the second end condition is satisfied (Step S220; Yes), the processing proceeds to Step S230.

In Step S230, the notification processing unit 130 ends the second notification processing.

As with the case of the first example described above, a plurality of types of the second notification processing may be performed in stages.

### 3-2-3. Third Example

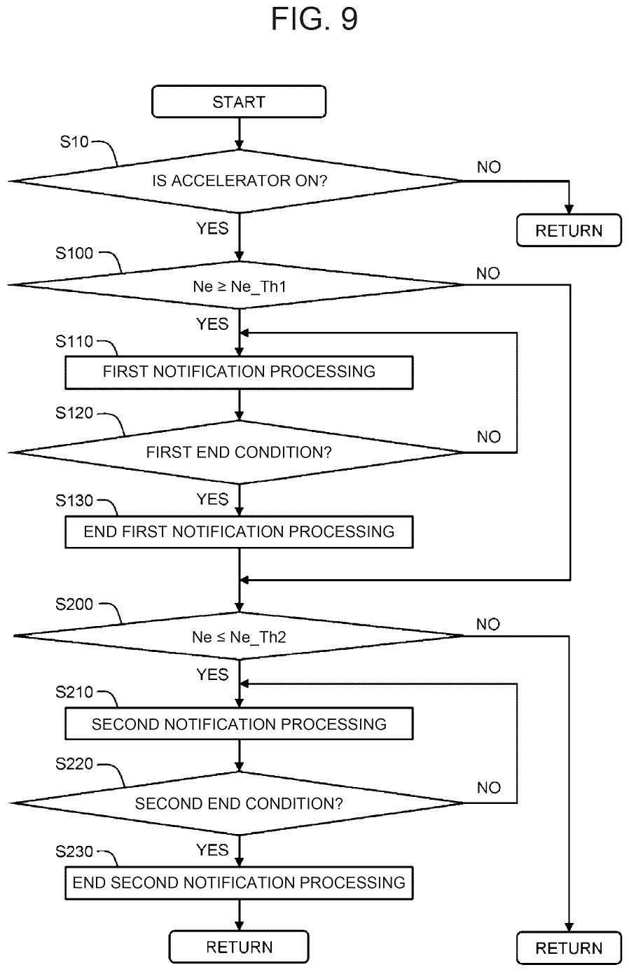

FIG. 9 is a flowchart showing a third example of the processing relating to the notification processing in the simulation mode. The third example is a combination of the first example (FIG. 6) and the second example (FIG. 8). The second actuation threshold value Ne_Th2 is lower than the first actuation threshold value Ne_Th1. According to the third example, both of the effect obtained by the first example and the effect obtained by the second example are obtained.

### 4. Various Example of Torque-based Notification Processing

Various examples of the torque-based notification processing out of the notification processing is particularly described below.

### 4-1. First Example

FIG. 10 is a block diagram showing a functional configuration example relating to a first example of the torque-based notification processing in the simulation mode. The vehicle control system 100 includes the required torque calculation unit 110, the condition determination unit 120, the torque-based notification processing unit 131, and the motor control unit 140.

The required torque calculation unit 110 includes a virtual engine torque map 115. The required torque calculation unit 110 calculates the virtual engine output torque Teout in accordance with the accelerator operation amount Pap and the virtual engine rotation speed Ne by using the virtual engine torque map 115. The required torque calculation unit 110 calculates the required torque Tr from the virtual engine output torque Teout by taking the virtual gear stage GP, the speed reduction ratio, and the like into consideration. The required torque Tr calculated by the required torque calculation unit 110 is referred to as the basic required torque Tr0 for convenience.

The condition determination unit 120 determines whether a first start condition (notification start condition) is satisfied. The first start condition is that the virtual engine rotation speed Ne becomes equal to or more than a first actuation threshold value Ne_Th1. When the first start condition is satisfied, the condition determination unit 120 instructs the torque-based notification processing unit 131 to start the torque-based notification processing. After the start of the torque-based notification processing, the condition determination unit 120 determines whether a first end condition (notification end condition) is satisfied. When the first end condition is satisfied, the condition determination unit 120 instructs the torque-based notification processing unit 131 to end the torque-based notification processing.

The torque-based notification processing unit 131 sets the additional torque component Tadd without using the virtual engine torque map 115. The additional torque component Tadd may be a torque vibration component. The torque-based notification processing unit 131 acquires the final required torque Tr by superimposing the additional torque component Tadd onto the basic required torque Tr0 output from the required torque calculation unit 110.

The motor control unit 140 controls the electric motor 44 in accordance with the required torque Tr after the additional torque component Tadd is superimposed.

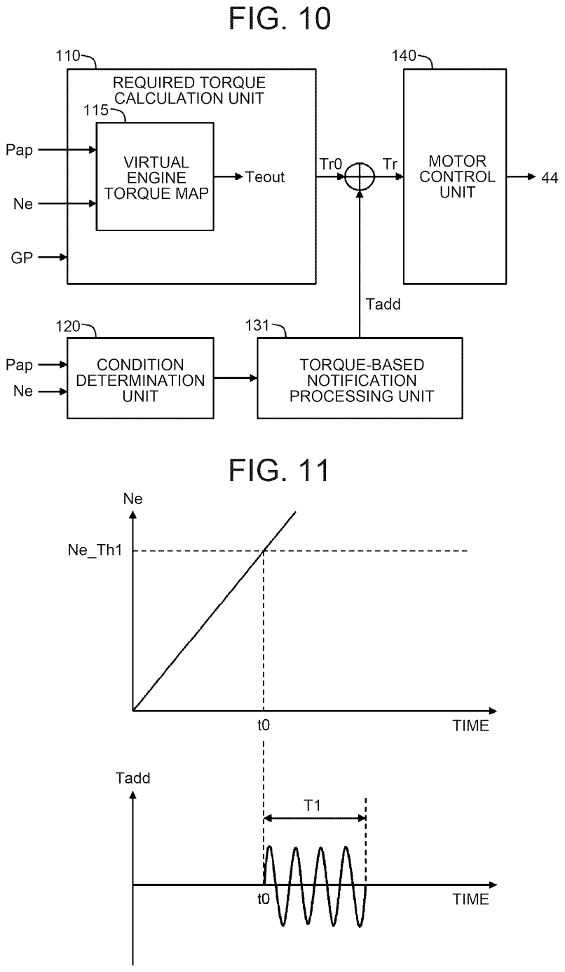

FIG. 11 is a timing chart for describing the first example of the torque-based notification processing. The horizontal axis indicates time, and the vertical shaft indicates the virtual engine rotation speed Ne or the additional torque component Tadd.

The driver of the vehicle 10 steps on the accelerator pedal. The virtual engine rotation speed Ne of the virtual engine car increases with time. At a time point t0, the virtual engine rotation speed Ne reaches the first actuation threshold value Ne_Th1, and the first start condition is satisfied. The torque-based notification processing is started, and the additional torque component Tadd is superimposed onto the required torque Tr. As a result, the driving force and the behavior of the vehicle 10 fluctuate by the amount of the additional torque component Tadd. As a result, the driver can recognize that the virtual engine rotation speed Ne has become excessively high. It is expected that the driver reduces the depression of the accelerator pedal and the virtual engine rotation speed Ne is reduced.

As exemplified in FIG. 11, the additional torque component Tadd may be a torque vibration component. In other words, the additional torque component Tadd may vibrate so as to alternate between a positive value and a negative value. The waveform of the torque vibration component is freely set. The torque vibration component is superimposed onto the required torque Tr, and hence the vibration of the vehicle 10 in accordance with the torque vibration component occurs. The vehicle 10 vibrates, and hence the notification to the driver becomes clearer. The driver can more clearly recognize that the virtual engine rotation speed Ne has become excessively high.

The first actuation threshold value Ne_Th1 may be an upper-limit value Ne_lim of the engine rotation speed assumed in the virtual engine car to be simulated. When the basic required torque Tr0 is calculated in the required torque calculation unit 110, the virtual engine rotation speed Ne may be limited to be equal to or less than the upper-limit value Ne_lim. When the first actuation threshold value Ne_Th1 is the upper-limit value Ne_lim, it becomes possible to notify the driver that the virtual engine rotation speed Ne has reached the upper-limit value Ne_lim. It is expected that the driver reduces the depression of the accelerator pedal and the virtual engine rotation speed Ne is reduced.

The first actuation threshold value Ne_Th1 may be the upper-limit value Ne_lim, and the additional torque component Tadd may be a torque vibration component. In this case, it becomes possible to simulate a vehicle vibration due to fuel cut by the torque-based notification processing. As a result, it becomes possible for the driver to more clearly recognize that the virtual engine rotation speed Ne has reached the upper-limit value Ne_lim.

In the example shown in FIG. 11, the additional torque component Tadd is superimposed onto the required torque Tr for a predetermined amount of time T1. The predetermined amount of time T1 is one second, for example. After the predetermined amount of time T1 elapses from a time point t0, the application of the additional torque component Tadd ends. In other words, the torque-based notification processing ends after the predetermined amount of time T1 elapses from the start of the torque-based notification processing. This is one example of the first end condition.

### 4-2. Second Example

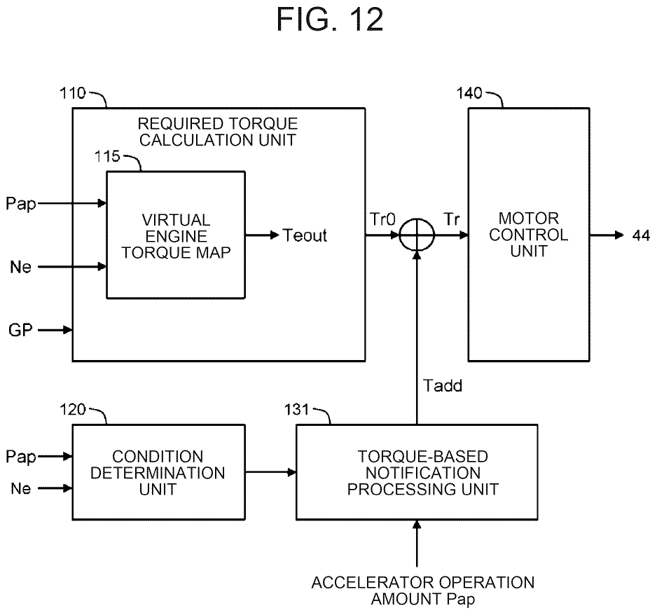

FIG. 12 is a block diagram showing a functional configuration example relating to a second example of the torque-based notification processing. Descriptions overlapping with the case of the first example shown in FIG. 10 are omitted, as appropriate. According to the second example, the accelerator operation amount Pap is input to the torque-based notification processing unit 131.

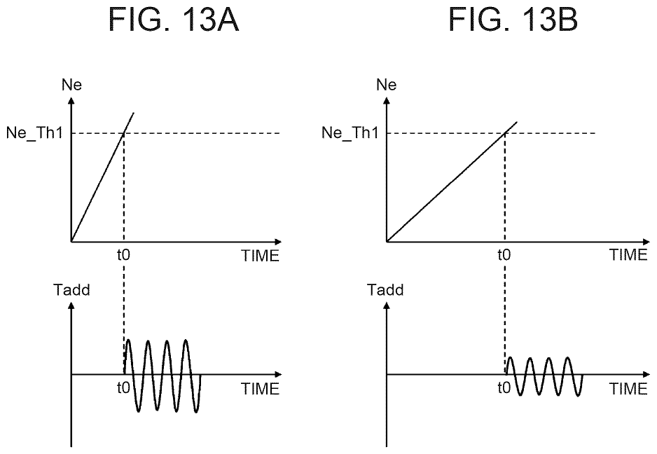

FIG. 13 is a timing chart for describing the second example of the torque-based notification processing. Descriptions overlapping with the case of the first example shown in FIG. 11 are omitted, as appropriate. According to the second example, the magnitude of the additional torque component Tadd fluctuates in accordance with the accelerator operation amount Pap. More specifically, the additional torque component Tadd becomes larger as the accelerator operation amount Pap becomes higher.

FIG. 13A shows a case of strong acceleration in which the accelerator operation amount Pap is relatively high. In the case of strong acceleration, the additional torque component Tadd is set to be large. FIG. 13B shows a case of intermediate acceleration in which the accelerator operation amount Pap is relatively low. In the case of intermediate acceleration, the additional torque component Tadd is set to be smaller than the case of the strong acceleration. In a case of gradual acceleration in which the accelerator operation amount Pap is even lower, the additional torque component Tadd may be set to zero. In the case of gradual acceleration, as with throttle closing control of a conventional vehicle, the virtual engine rotation speed Ne may smoothly converge to the upper-limit value Ne_lim.

When generalized, the additional torque component Tadd when the accelerator operation amount Pap is a first accelerator operation amount is larger than the additional torque component Tadd when the accelerator operation amount Pap is a second accelerator operation amount that is lower than the first accelerator operation amount. By setting the additional torque component Tadd by taking the accelerator operation amount Pap into consideration, it becomes possible to reproduce a more realistic driving feeling.

### 4-3. Third Example

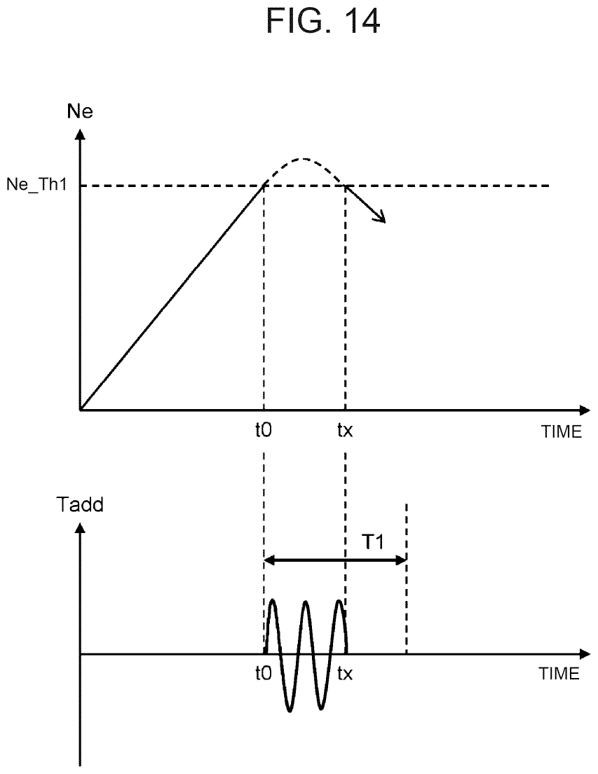

FIG. 14 is a timing chart for describing the third example of the torque-based notification processing. Descriptions overlapping with the case of the first example shown in FIG. 11 are omitted, as appropriate.

At a time point t0, the virtual engine rotation speed Ne reaches the first actuation threshold value Ne_Th1, the first start condition is satisfied, and the torque-based notification processing is started. The driver reduces the depression of the accelerator pedal. At a time point tx, the virtual engine rotation speed Ne falls below the first actuation threshold value Ne_Th1, and the first start condition is no longer satisfied. The time point tx is a time point before the predetermined amount of time T1 elapses from the time point t0. In this case, the torque-based notification processing ends at the time point tx that is a time point before the predetermined amount of time T1 elapses. This is one example of the first end condition as well.

### 4-4. Fourth Example

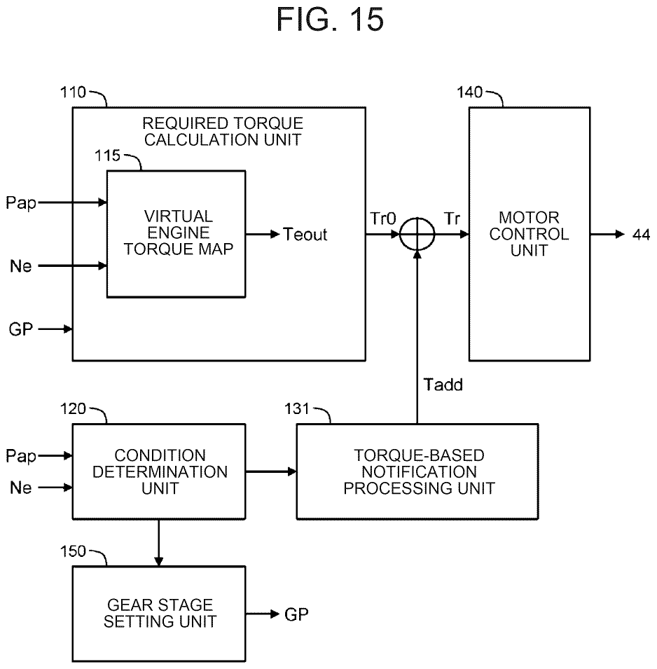

FIG. 15 is a block diagram showing a functional configuration example relating to a fourth example of the torque-based notification processing. The vehicle control system 100 further includes a gear stage setting unit 150. The gear stage setting unit 150 automatically returns the virtual engine rotation speed Ne to a suitable value by automatically setting the virtual gear stage GP to a predetermined appropriate gear stage when the torque-based notification processing ends.

In particular, a case in which the first end condition is a condition that “the predetermined amount of time T1 elapses from the start of the torque-based notification processing” is conceived. The torque-based notification processing ends when the first end condition is satisfied, but a possibility of the virtual engine rotation speed Ne still being equal to or more than the first actuation threshold value Ne_Th1 is high at this time. The appropriate gear stage is the virtual gear stage GP at which the virtual engine rotation speed Ne that has been equal to or more than the first actuation threshold value Ne_Th1 becomes lower than the first actuation threshold value Ne_Th1. The appropriate gear stage is defined in advance. The gear stage setting unit 150 automatically sets the virtual gear stage GP to a predetermined appropriate gear stage when the first end condition is satisfied. As a result, the virtual engine rotation speed Ne is automatically reduced to an appropriate value.

### 5. Specific Example of Simulation Mode

An electric motor that is used as a travel motive power device in a general electric vehicle has a largely different torque characteristic from an internal combustion engine that is used as a travel motive power device in a conventional vehicle (CV). Because of the difference in torque characteristic of the motive power device, electric vehicles generally do not include a transmission while a transmission is essential to CVs. General electric vehicles naturally do not include a manual transmission (MT) that changes gear ratios through a manual operation by a driver. Accordingly, there is a large difference in driving sensation between driving of a conventional vehicle with an MT (hereinafter, referred to as an MT vehicle) and driving of an electric vehicle.

Meanwhile, in the electric motor, the torque can be relatively easily controlled by controlling the voltage and magnetic field that are applied. Accordingly, in the electric motor, it is possible to obtain a desired torque characteristic within the operating range of the electric motor, by executing an adequate control. By utilizing such a characteristic, a torque characteristic specific to an MT vehicle can be simulated by controlling torque for an electric vehicle. The electric vehicle can also be provided with a pseudo-shifter such that the driver can experience a driving sensation as in an MT vehicle. Thus, it becomes possible to simulate an MT vehicle in the electric vehicle.

In other words, the electric vehicle controls the output of the electric motor so as to simulate the driving characteristic (torque characteristic) specific to an MT vehicle. The driver performs a pseudo-manual transmission operation by operating the pseudo-shifter. In response to the pseudo-manual transmission operation performed by the driver, the electric vehicle simulates an MT vehicle and changes the driving characteristic (torque characteristic). As a result, the driver of the electric vehicle can experience a sensation as if driving an MT vehicle. A control mode of the electric motor for simulating a driving characteristic and a manual transmission operation of an MT vehicle as described above is hereinafter referred to as a “manual mode” or an “MT mode”. The manual mode or the MT mode is equivalent to the “simulation mode”.

In the following, a case in which the vehicle 10 according to the present disclosure is an electric vehicle including the MT mode is conceived. In the MT mode, the electric vehicle may generate a simulated engine sound in accordance with a driving operation of the driver and output the simulated engine sound via the speaker 70. Not only the driving operation of an MT vehicle but also the engine sound of an MT vehicle is reproduced, and hence the satisfaction level of a driver that wants reality increases. Configuration examples of the electric vehicle including the MT mode are described below. Examples of the MT mode include a “sequential shift mode” and a “three-pedal mode”.

### 5-1. First Configuration Example (Sequential Shifter)

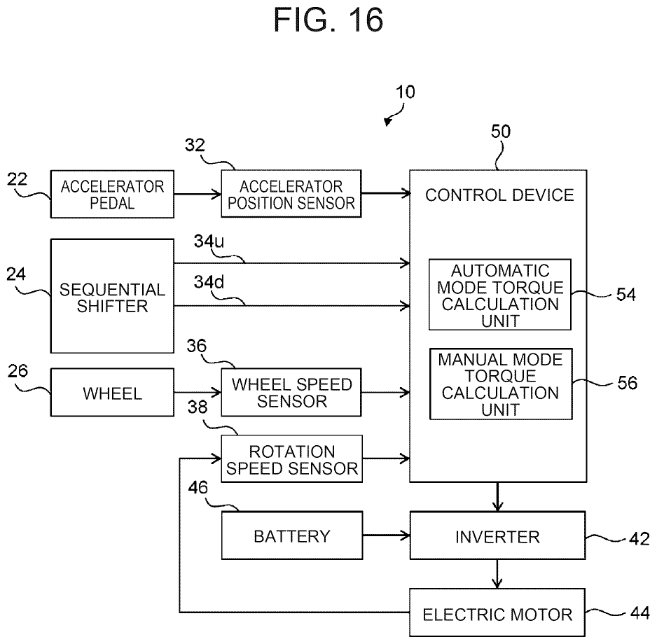

FIG. 16 is a block diagram showing a first configuration example of a motive power control system of the electric vehicle according to this embodiment. The electric vehicle includes the electric motor 44, a battery 46, and an inverter 42. The electric motor 44 is a travel motive power device. The battery 46 stores therein electric energy that drives the electric motor 44. In other words, the electric vehicle is a battery electric vehicle (BEV) that travels by electric energy stored in the battery 46. At the time of acceleration, the inverter 42 converts direct-current electricity input from the battery 46 into driving electricity for the electric motor 44. At the time of deceleration, the inverter 42 converts regenerative electricity input from the electric motor 44 into direct-current electricity and charges the battery 46 with the direct-current electricity.

The electric vehicle includes an accelerator pedal 22 through which the driver inputs an acceleration request to the electric vehicle. The accelerator pedal 22 is provided with an accelerator position sensor 32 for detecting an accelerator operation amount.

The electric vehicle includes a sequential shifter 24. The sequential shifter 24 may be paddle shifters, or a lever-type pseudo-shifter.

The paddle shifters are dummies that are different from true paddle shifters. The paddle shifters have a structure resembling paddle shifters included in an MT vehicle without a clutch pedal. The paddle shifters are attached to a steering wheel. The paddle shifters include an up-shift switch and a down-shift switch that determine an operation position. The up-shift switch issues an up-shift signal 34u by being pulled toward the driver, and the down-shift switch issues a down-shift signal 34d by being pulled toward the driver.

As with the paddle shifters, the lever-type pseudo-shifter is a dummy that is different from a true shifter. The lever-type pseudo-shifter has a structure resembling a lever shifter included in an MT vehicle without a clutch pedal. The lever-type pseudo-shifter is configured to output the up-shift signal 34u by moving down the shift lever toward the front, and to output the down-shift signal 34d by moving down the shift lever toward the rear.

A wheel 26 of the electric vehicle is provided with a wheel speed sensor 36. The wheel speed sensor 36 is used as a vehicle speed sensor for detecting the vehicle speed of the electric vehicle. The electric motor 44 is provided with a rotation speed sensor 38 for detecting its rotation speed.

The electric vehicle includes a control device 50. The control device 50 is included in the vehicle control system 100 described above. The control device 50 is typically an electronic control unit (ECU) installed in the electric vehicle. The control device 50 may be a combination of a plurality of ECUs. The control device 50 includes an interface, a memory, and a processor. An in-vehicle network is connected to the interface. The memory includes a RAM on which data is temporarily recorded, and a ROM in which a processor-executable program and various kinds of data related to the program are retained. The program includes a plurality of instructions. The processor reads programs and data from the memory, to execute the program and the data, and generates a control signal based on signals that are acquired from sensors.

For example, the control device 50 controls the electric motor 44 through PWM control of the inverter 42. Signals from the accelerator position sensor 32, the sequential shifter 24 (the up-shift switch and the down-shift switch when the sequential shifter 24 is paddle shifters), the wheel speed sensor 36, and the rotation speed sensor 38 are input into the control device 50. The control device 50 processes the signals and calculates a motor torque instruction value for PWM control of the inverter 42.

The control device 50 includes an automatic mode (EV mode) and a manual mode (MT mode) as control modes. The automatic mode is a normal control mode for driving the electric vehicle as a general electric vehicle. The automatic mode is programmed to cause outputs of the electric motor 44 to continuously change according to operation of the accelerator pedal 22. Meanwhile, the manual mode is a control mode for driving the electric vehicle like an MT vehicle. The manual mode is programmed to cause an output characteristic of the electric motor 44 responding to operation of the accelerator pedal 22 to change according to up-shift operation and down-shift operation of the sequential shifter 24. The manual mode (MT mode) corresponds to the “sequential shift mode”. Switching between the automatic mode and the manual mode is possible.

The control device 50 includes an automatic mode torque calculation unit 54 and a manual mode torque calculation unit 56. The units 54, 56 may be ECUs independent from each other, or may be ECU functions obtained as a result of programs recorded on the memory being executed by the processor.

The automatic mode torque calculation unit 54 includes a function of calculating a motor torque in a case of controlling the electric motor 44 in the automatic mode. A motor torque instruction map is stored in the automatic mode torque calculation unit 54. The motor torque instruction map is a map that determines a motor torque from the accelerator operation amount and the rotation speed of the electric motor 44. A signal from the accelerator position sensor 32 and a signal from the rotation speed sensor 38 are input into parameters of the motor torque instruction map. A motor torque corresponding to the signals is output from the motor torque instruction map. Accordingly, in the automatic mode, even when the driver operates the sequential shifter 24, the operation is not reflected in the motor torque.

The manual mode torque calculation unit 56 includes an MT vehicle model. The MT vehicle model is a model for calculating a drive wheel torque to be obtained by the operation of the accelerator pedal 22 and the sequential shifter 24 under the assumption that the electric vehicle is an MT vehicle.

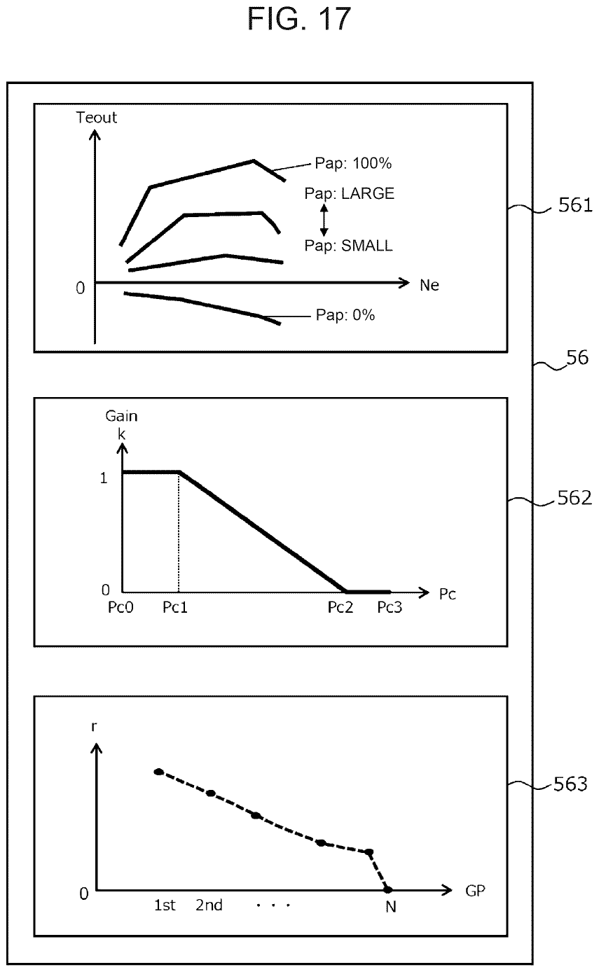

The MT vehicle model included in the manual-mode torque calculation unit 56 is described with reference to FIG. 17. As shown in FIG. 17, the MT vehicle model includes an engine model 561, a clutch model 562, and a transmission model 563. An engine, a clutch, and a transmission that are virtually realized by the MT vehicle model are referred to as a virtual engine, a virtual clutch, and a virtual transmission, respectively. In the engine model 561, the virtual engine is modeled. In the clutch model 562, the virtual clutch is modeled. In the transmission model 563, the virtual transmission is modeled.

The engine model 561 calculates the virtual engine rotation speed Ne and the virtual engine output torque Teout. The virtual engine rotation speed Ne is calculated based on the wheel rotation speed Nw, a total speed reduction ratio R, and a virtual clutch slip ratio Rslip. For example, the virtual engine rotation speed Ne is represented by a following expression (1).

$$Ne = Nw \times R / ( 1 - Rslip ) \qquad Expression ( 1 )$$

The virtual engine output torque Teout is calculated from the virtual engine rotation speed Ne and an accelerator operation amount Pap. As shown in FIG. 17, for the calculation of the virtual engine output torque Teout, a map (virtual engine torque map 115) specifying relationships among the accelerator operation amount Pap, the virtual engine rotation speed Ne, and the virtual engine output torque Teout is used. In this map, the virtual engine output torque Teout with respect to the virtual engine rotation speed Ne is given for each accelerator operation amount Pap. The torque characteristic shown in FIG. 17 can be set as a characteristic for which a gasoline engine is assumed, or can be set as a characteristic for which a diesel engine is assumed. The torque characteristics can be set to characteristics supposing a naturally aspirated engine, or to characteristics supposing a supercharged engine.

The clutch model 562 calculates a torque transmission gain k. The torque transmission gain k is a gain for calculating the degree of transmission of the torque of the virtual clutch according to a virtual clutch operation amount Pc. The virtual clutch operation amount Pc is normally 0%, and is temporarily increased up to 100% in conjunction with switching of a virtual gear stage of the virtual transmission. The clutch model 562 includes a map shown in FIG. 17. In this map, the torque transmission gain k is given with respect to the virtual clutch operation amount Pc. In FIG. 17, Pc0 corresponds to a position at which the virtual clutch operation amount Pc is 0%, and Pc3 corresponds to a position at which the virtual clutch operation amount Pc is 100%. The range of Pc0 to Pc1 and the range of Pc2 to Pc3 are dead zones in which the torque transmission gain k does not change with the virtual clutch operation amount Pc. The clutch model 562 uses the torque transmission gain k to calculate a clutch output torque Tcout. The clutch output torque Tcout is a torque output from the virtual clutch. For example, the clutch output torque Tcout is given as the product of the virtual engine output torque Teout and the torque transmission gain k (Tcout=Teout×k).

The clutch model 562 calculates the slip ratio Rslip. The slip ratio Rslip is used in the calculation of the virtual engine rotation speed Ne by the engine model 561. For the calculation of the slip ratio Rslip, a map in which the slip ratio Rslip is given with respect to the virtual clutch operation amount Pc can be used as with the torque transmission gain k.

The transmission model 563 calculates a gear ratio r. The gear ratio r is a gear ratio determined by the virtual gear stage GP in the virtual transmission. The virtual gear stage GP is up-shifted by one stage in response to up-shift operation of the sequential shifter 24. Meanwhile, the virtual gear stage GP is down-shifted by one stage in response to down-shift operation of the sequential shifter 24. The transmission model 563 has a map as shown in FIG. 17. In this map, the gear ratio r is given with respect to the virtual gear step GP such that the gear ratio r becomes lower as the virtual gear step GP becomes higher. The transmission model 563 uses the gear ratio r obtained from the map and the clutch output torque Tcout to calculate a transmission output torque Tgout. For example, the transmission output torque Tgout is given as the product of the clutch output torque Tcout and the gear ratio r (Tgout=Tcout×r). The transmission output torque Tgout discontinuously changes in response to the switching of the gear ratio r. The discontinuous change in the transmission output torque Tgout causes gearshift shock, which stages a typical feature of a vehicle with a multistage transmission.

The MT vehicle model calculates the drive wheel torque Tw with use of a predetermined speed reduction ratio rr. The speed reduction ratio rr is a fixed value determined by a mechanical structure from the virtual transmission to the drive wheel. A value obtained by multiplying the speed reduction ratio rr by the gear ratio r is the total reduction ratio R. The MT vehicle model calculates the drive wheel torque Tw from the transmission output torque Tgout and the speed reduction ratio rr. For example, the drive wheel torque Tw is given as the product of the transmission output torque Tgout and the speed reduction ratio rr (Tw=Tgout×rr).

The control device 50 converts the drive wheel torque Tw calculated by the MT vehicle model into the required motor torque Tm. The required motor torque Tm is a motor torque needed to realize the drive wheel torque Tw calculated by the MT vehicle model. In the conversion of the drive wheel torque Tw into the required motor torque Tm, a speed reduction ratio from the output shaft of the electric motor 44 to the drive wheel is used. Then, the control device 50 controls the electric motor 44 by controlling the inverter 42 in accordance with the required motor torque Tm.

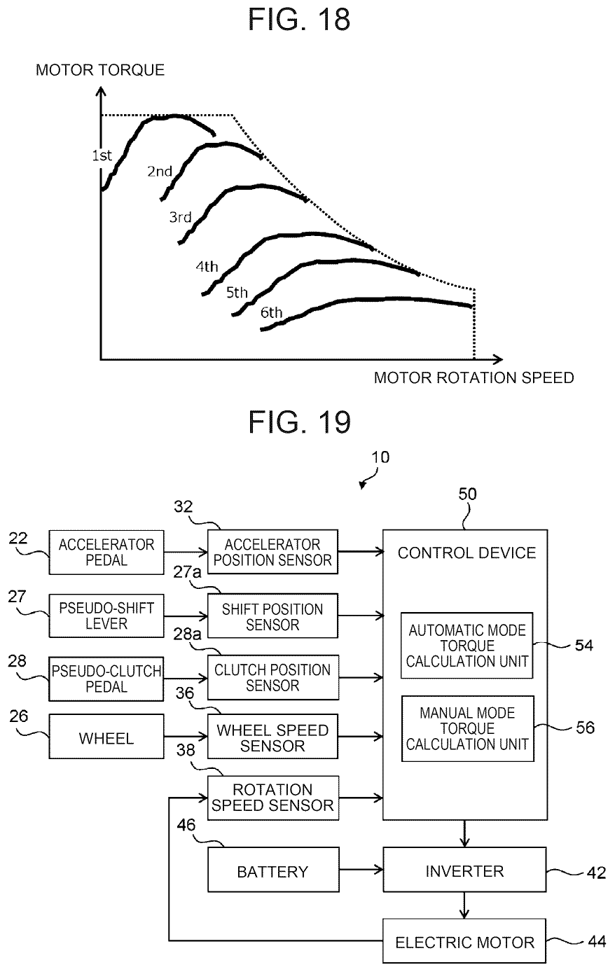

FIG. 18 shows torque characteristics of the electric motor 44 realized through motor control using the MT vehicle model, in comparison with a torque characteristic of the electric motor 44 realized through normal motor control for an electric vehicle (EV). A dotted line in FIG. 18 indicates the torque characteristic of a normal electric vehicle. As shown in FIG. 18, the motor control using the MT vehicle model can realize torque characteristics (solid lines in FIG. 18) that simulate the torque characteristics of an MT vehicle in accordance with the virtual gear stage selected by the sequential shifter 24. In FIG. 18, the number of gear stages is six.

### 5-2. Second Exemplary Configuration (Three-Pedal Mode)

FIG. 19 is a block diagram showing a second configuration example of a motive power control system of the electric vehicle according to this embodiment. Here, a description is given only of components that are different from the first configuration example described above. Specifically, in the second configuration example, the electric vehicle includes a pseudo-shift lever (pseudo-shift device) 27 and a pseudo-clutch pedal 28 instead of the sequential shifter 24 included in the first configuration example. The pseudo-shift lever 27 and the pseudo-clutch pedal 28 are merely dummies that are different from a true shift lever and a true clutch pedal.

The pseudo-shift lever 27 has a structure that simulates a shift lever included in an MT vehicle. Arrangement and an operational feeling of the pseudo-shift lever 27 are similar to those of an actual MT vehicle. For the pseudo-shift lever 27, for example, positions corresponding to gear steps: first gear, second gear, third gear, forth gear, fifth gear, sixth gear, reverse, and neutral are provided. The pseudo-shift lever 27 is provided with a shift position sensor 27a that detects the gear step by discriminating the position where the pseudo-shift lever 27 is placed.

The pseudo-clutch pedal 28 has a structure that simulates a clutch pedal included in an MT vehicle. Arrangement of and an operational feeling of the pseudo-clutch pedal 28 are similar to those of an actual MT vehicle. The pseudo-clutch pedal 28 is operated when the pseudo-shift lever 27 is operated. In other words, the driver depresses the pseudo-clutch pedal 28 when the driver wants to change gear stage settings by using the pseudo-shift lever 27, and, when the change in gear stage setting is finished, ceases from depressing to bring the pseudo-clutch pedal 28 back to the original position. The pseudo-clutch pedal 28 is provided with a clutch position sensor 28a that detects the depressing amount of the pseudo-clutch pedal 28.

Signals from the accelerator position sensor 32, the shift position sensor 27a, the clutch position sensor 28a, the wheel speed sensor 36, and the rotation speed sensor 38 are input into the control device 50. The control device 50 processes those signals and calculates a motor torque instruction value for PWM control of the inverter 42.

As in the first configuration example described above, the control device 50 includes an automatic mode and a manual mode as control modes. The automatic mode is programmed to cause outputs of the electric motor 44 to continuously change in accordance with operation of the accelerator pedal 22. Meanwhile, the manual mode is a control mode for driving the electric vehicle like an MT vehicle. The manual mode is programmed to cause outputs and an output characteristic of the electric motor 44 responding to the operation of the accelerator pedal 22 to change in accordance with the operation of the pseudo-clutch pedal 28 and the pseudo-shift lever (pseudo-shift device) 27. The manual mode (MT mode) corresponds to the “three-pedal mode”. Switching between the automatic mode and the manual mode is possible.

The vehicle model included in the manual-mode torque calculation unit 56 is the same as the vehicle model shown in FIG. 17. However, the virtual clutch operation amount Pc is replaced with the amount of depression of the pseudo-clutch pedal 28 detected by the clutch position sensor 28a. The virtual gear stage GP is determined by a position of the pseudo-shift lever 27 detected by the shift position sensor 27a.

What is claimed is:

1. A vehicle control system to be applied to a vehicle including an electric motor as a driving source, the vehicle control system comprising one or more processors configured to control the electric motor so as to simulate a driving characteristic of a virtual engine car in a simulation mode, wherein, in the simulation mode, the one or more processors are configured to:
calculate a virtual engine output torque of the virtual engine car based on an accelerator operation amount of the vehicle;
control the electric motor in accordance with a required torque obtained from the virtual engine output torque; and
start torque-based notification processing of superimposing an additional torque component onto the required torque when a notification start condition is satisfied.

2. The vehicle control system according to claim 1, wherein the additional torque component is a torque vibration component.

3. The vehicle control system according to claim 2, wherein the torque vibration component is superimposed onto the required torque for a predetermined amount of time.

4. The vehicle control system according to claim 1, further comprising one or more storage devices configured to store a virtual engine torque map that defines a relationship between the accelerator operation amount and the virtual engine output torque in the one or more storage devices, wherein, in the simulation mode, the one or more processors are configured to:
calculate the virtual engine output torque in accordance with the accelerator operation amount by using the virtual engine torque map; and
set the additional torque component without using the virtual engine torque map.

5. The vehicle control system according to claim 1, wherein the one or more processors are configured to end the torque-based notification processing when a notification end condition is satisfied after the torque-based notification processing is started.

6. The vehicle control system according to claim 5, wherein the notification end condition is that a predetermined amount of time elapses from the start of the torque-based notification processing.

7. The vehicle control system according to claim 5, wherein the notification end condition is that the notification start condition is no longer satisfied.

8. The vehicle control system according to claim 1, wherein:
the one or more processors are configured to calculate a virtual engine rotation speed of the virtual engine car in the simulation mode; and
the notification start condition includes a condition that the virtual engine rotation speed becomes equal to or more than a first actuation threshold value.

9. The vehicle control system according to claim 8, wherein the first actuation threshold value is an upper-limit value of an engine rotation speed that is assumed in the virtual engine car to be simulated.

10. The vehicle control system according to claim 8, wherein the additional torque component when the accelerator operation amount is a first accelerator operation amount is larger than the additional torque component when the accelerator operation amount is a second accelerator operation amount that is lower than the first accelerator operation amount.

11. The vehicle control system according to claim 8, wherein the one or more processors are configured to:
end the torque-based notification processing when a predetermined amount of time elapses from the start of the torque-based notification processing; and
automatically set a gear stage of the virtual engine car to a predetermined appropriate gear stage when the torque-based notification processing is ended.

12. The vehicle control system according to claim 1, wherein:
the one or more processors are configured to calculate a virtual engine rotation speed of the virtual engine car in the simulation mode; and
the notification start condition includes a condition that the virtual engine rotation speed becomes equal to or less than a second actuation threshold value.

13. The vehicle control system according to claim 1, wherein:
the one or more processors are configured to calculate a virtual engine rotation speed of the virtual engine car in the simulation mode; and
the notification start condition includes a condition that the virtual engine rotation speed is equal to or more than a first actuation threshold value or a condition that the virtual engine rotation speed becomes equal to or less than a second actuation threshold value lower than the first actuation threshold value.

14. A vehicle control system to be applied to a vehicle including an electric motor as a driving source, the vehicle control system comprising one or more processors configured to control the electric motor so as to simulate a driving characteristic of a virtual engine car in a simulation mode, wherein, in the simulation mode, the one or more processors are configured to:
calculate a virtual engine rotation speed of the virtual engine car; and
start notification processing of notifying a driver of the vehicle that the virtual engine rotation speed has become equal to or less than a threshold value when the virtual engine rotation speed becomes equal to or less than the threshold value.

15. The vehicle control system according to claim 14, wherein:
the one or more processors are configured to, in the simulation mode:
calculate a virtual engine output torque of the virtual engine car based on an accelerator operation amount of the vehicle; and
control the electric motor in accordance with a required torque obtained from the virtual engine output torque; and
the notification processing includes torque-based notification processing of superimposing an additional torque component onto the required torque.

16. The vehicle control system according to claim 15, wherein the additional torque component is a torque vibration component.
